(19) United States
(12) Patent Application Publication
(10) Pub. No.: US 2026/0299534 A1
(43) Pub. Date: Oct. 1, 2026

(54) BAYESIAN OPTIMIZATION WITH DIVERSITY SEARCH FOR DISTURBANCE MODELING IN ADAPTIVE CONTROL

(71) Applicant: Mitsubishi Electric Research Laboratories, Inc., Cambridge, MA (US)

(72) Inventors: Ankush Chakrabarty, Bedford, MA (US); Joel Paulson, Columbus, OH (US)

(73) Assignee: Mitsubishi Electric Research Laboratories, Inc., Cambridge, MA (US)

(21) Appl. No.: 19/089,791

(22) Filed: Mar. 25, 2025

(51) Int. Cl. G05B 13/04; G05B 13/02; G06N 3/08

(52) U.S. Cl. CPC G05B 13/04; G05B 13/027; G06N 3/08

(57) ABSTRACT

A method and system for adaptive control of a mechanical system subject to disturbances are disclosed. A processor executes instructions to control the system using a current controller while collecting historical disturbances. A time-series generative AI model, including an encoder-decoder architecture, is trained on the collected disturbances to generate a probabilistic distribution of disturbance scenarios. A surrogate model maps latent vectors from the generative AI model's latent space to simulation engine outputs, optimizing the model using Bayesian optimization-based diversity search to identify diverse disturbance scenarios. The identified scenarios are used to update the current controller, improving robustness against previously unobserved disturbances. In various implementations, the system integrates a novelty metric and an acquisition function to balance exploration and exploitation. The disclosed approach enhances control system adaptability across various applications, including power grids, autonomous systems, and industrial automation, by identifying and responding to dynamic disturbances.

### TECHNICAL FIELD

The present disclosure relates to the field of adaptive control systems and disturbance modeling, particularly for dynamical systems operating under unpredictable conditions. It specifically concerns methods integrating Bayesian optimization with diversity search, surrogate process modeling, and generative AI techniques to systematically identify and model diverse disturbance scenarios. The disclosed solutions find applications across various domains of dynamical systems, including autonomous systems, power grid management, aerospace, HVAC control, and industrial automation, where resilience to unforeseen disturbances is advantageous.

### BACKGROUND

Modern dynamical systems operate in environments that are subject to unpredictable and multi-dimensional disturbances, which can significantly impact system stability and performance. These disturbances arise from a variety of sources, including environmental variations, unexpected system faults, and external disruptions. In safety-critical applications such as autonomous navigation, power grid management, aerospace control, and industrial automation, the ability to anticipate and mitigate such disturbances is essential for ensuring reliability and efficiency.

Traditionally, control strategies are designed and optimized based on historical disturbance data. This approach assumes that future disturbances will resemble past events, allowing controllers to be fine-tuned based on previously observed patterns. However, this assumption is often flawed, as real-world disturbances are dynamic and may exhibit behaviors that were not present in the training data. Additionally, expert-designed disturbance scenarios are commonly used to test system resilience under specific failure modes or operational edge cases. While this manual approach provides valuable insights, it is inherently limited by human foresight and computational feasibility. The design of such scenarios requires extensive domain expertise, significant computational resources, and time-consuming trial-and-error processes, ultimately restricting the ability to explore novel, extreme, or highly complex disturbances.

The limitations of conventional approaches become evident when a system encounters disturbances that were not previously observed or anticipated. Controllers optimized for a fixed set of disturbances may perform inadequately under unseen conditions, leading to degraded performance, instability, or even system failure. This challenge is particularly pronounced in applications involving high-dimensional and stochastic environments, where disturbances cannot be easily predicted or pre-modeled.

Accordingly, there exists a need for a systematic, automated, and data-driven approach to disturbance modeling that extends beyond historical data and human-defined scenarios, thereby enabling controllers to be adaptively tuned for a broader range of operating conditions.

### SUMMARY

To address these challenges, some embodiments disclose a control method that integrates a time-series generative AI model, such as a time-series foundational model (TSFM), a Bayesian optimization-based diversity search, and a surrogate model to facilitate the identification of disturbance scenarios that yield diverse simulated system responses. The method takes advantage of collecting historical disturbances while the system operates under the control of an existing controller. The collected disturbances serve as an initial dataset that characterizes past system responses and forms a baseline for training a generative model that captures the underlying structure of the disturbance environment.

Unlike approaches that directly optimize a control strategy based solely on past disturbances, the disclosed method leverages a surrogate model not as a predictive tool in isolation, but as a means to conduct Bayesian optimization-based diversity search. Instead of applying Bayesian optimization after model construction, the disclosed approach integrates Bayesian optimization during the construction of the surrogate model itself, utilizing an acquisition function that selects disturbance scenarios not based on achieving an optimal outcome but rather based on identifying scenarios that result in system responses that have not been observed before. By focusing on disturbance scenario diversity rather than model accuracy alone, the method enables the discovery of novel disturbances that may not have been present in historical data, allowing for adaptive control system enhancements that improve system resilience against both previously observed and unanticipated disturbances.

Rather than limiting the generative model to replicating past disturbances, the time-series generative AI model is fine-tuned using historical data while remaining capable of generating new disturbance scenarios that extend beyond previously recorded data. The tuning process can be performed more efficiently when the time-series generative AI model, e.g., the TSFM, is structured with an encoder-decoder architecture, wherein the encoder maps input disturbances into a compact latent space representation, and the decoder reconstructs disturbances from this latent space. By leveraging this architecture, the search for diverse disturbance scenarios is simplified, as the latent space provides a lower-dimensional, structured representation of disturbances, making it easier to explore and sample novel yet realistic scenarios. The encoder-decoder framework inherently organizes disturbances into a more manageable and semantically meaningful space, enabling a more effective application of Bayesian optimization-based diversity search.

By constructing the surrogate model between the latent space of the tuned TSFM and the output space of a simulation engine, the method achieves at least two objectives: reducing the dimensionality of the search space and ensuring that the resulting disturbance scenarios originate from the distribution of disturbances captured by the tuned TSFM. By constraining the search to disturbances that are realistic given the learned distribution, rather than arbitrary perturbations, the method ensures that the generated disturbance scenarios remain representative of real-world disturbances while maintaining computational efficiency.

Since running full-scale simulations for every possible disturbance scenario is computationally expensive, in some embodiments, the disclosed method reduces the number of simulation engine invocations by integrating Bayesian optimization-based diversity search during the surrogate model construction. The surrogate model is iteratively determined through an adaptive sampling process, wherein a disturbance scenario is selected from the latent space, and the simulation engine is invoked to determine the corresponding system outcome. The surrogate model is updated using Bayesian optimization (BO) with the selected scenario and its associated simulated outcome. The updated surrogate model is then sampled using an acquisition function that prioritizes scenarios that are likely to result in diverse system outcomes. This process continues, ensuring that only a limited number of simulations are required to obtain a diverse set of scenarios that comprehensively explore the range of possible system behaviors.

Instead of exhaustively running simulations for an arbitrary set of disturbances, the Bayesian optimization-based diversity search identifies scenarios that yield novel and diverse system responses while minimizing the number of simulation engine invocations. By iteratively refining the surrogate model, the method efficiently balances exploration and computational cost, ensuring that the set of discovered disturbances is both computationally feasible and representative of the system's full range of potential responses. This allows the control system to be updated in response to a broad set of disturbance conditions without requiring an exhaustive and impractical number of simulation evaluations.

Upon identifying a set of diverse disturbance scenarios, the control system is updated to incorporate the newly discovered conditions. Unlike conventional methods that merely tune controller parameters, the disclosed approach allows for fundamental modifications to the control strategy itself. The insights derived from the diversity search process may be utilized to adapt existing control policies, introduce new control strategies, or redesign control laws, thereby enhancing the system's ability to maintain stability and performance under previously unaccounted-for disturbances.

The disclosed framework is not limited to a specific application domain but is applicable to any complex dynamical system subject to unpredictable disturbances. In power grid applications, the method enables controllers to adapt to fluctuating energy demand and renewable energy variability. In aerospace applications, it can improve trajectory stability by compensating for unpredictable gravitational perturbations. In HVAC systems, the approach enhances energy efficiency and climate control in response to dynamic weather conditions and occupancy variations. In autonomous vehicles, it enhances navigation and decision-making in response to varying traffic patterns and environmental conditions. By enabling proactive adaptation rather than reactive tuning, the disclosed method provides a generalized solution for enhancing control system robustness across diverse operational environments.

Ultimately, this innovation transforms the manner in which control systems respond to disturbances by integrating historical learning, generative AI, Bayesian diversity search, and surrogate modeling into a unified approach. Instead of merely reacting to disturbances after they occur, the system anticipates, prepares for, and proactively adapts to them, thereby ensuring a higher degree of robustness, adaptability, and operational efficiency across a wide range of real-world applications.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A and FIG. 1B illustrates a schematic overview of a disturbance-aware control framework that integrates real-time sensor data, predictive disturbance modeling, and control updates to enhance system adaptability, in accordance with some embodiments.

FIG. 2A depicts the process of training and inference for generating disturbance scenarios using a time-series generative AI model, including encoding historical disturbance data and sampling new scenarios, in accordance with some embodiments.

FIG. 2B illustrates the Bayesian optimization-based diversity search process, which iteratively refines the surrogate model by selecting disturbance scenarios, simulating responses, and updating the model, in accordance with some embodiments.

FIG. 3A illustrates a schematic of a time-series generative AI model comprising a general encoder-decoder architecture, in accordance with some embodiments.

FIG. 3B shows a conditional variational autoencoder (CVAE) architecture for mapping disturbances to a structured latent space, enabling efficient generation of diverse disturbance scenarios, in accordance with some embodiments.

FIG. 4 presents an exemplary conditional probabilistic distribution of latent representations used to model partial disturbance observations for improved scenario generation, in accordance with some embodiments.

FIG. 5 provides a structured approach to modeling disturbances using generative AI, including real disturbance data, learned latent space representations, and synthetic disturbance scenarios, in accordance with some embodiments.

FIG. 6 illustrates a method for selecting disturbance scenarios that lead to diverse performance outcomes in a controlled system using novelty search and Bayesian optimization, in accordance with some embodiments.

FIG. 7 demonstrates the iterative refinement of a surrogate model using multi-output Gaussian processes (MOGP) and Bayesian optimization to improve disturbance scenario selection, in accordance with some embodiments.

FIG. 8 presents pseudocode for the BEACON method, a Bayesian optimization-inspired strategy for efficient novelty search in disturbance modeling, in accordance with some embodiments.

FIG. 9 provides an illustration of the iterative behavior of the BEACON method, showing how new disturbance scenarios are progressively selected to maximize diversity, in accordance with some embodiments.

FIG. 10A and FIG. 10B depict examples of single-output and multi-output test functions used to evaluate system performance under different disturbance conditions, in accordance with some embodiments.

FIG. 11 shows a schematic of a computing device that is representative of a system or collection of systems in which the various processes, programs, services, and scenarios of some embodiments disclosed herein are implemented.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

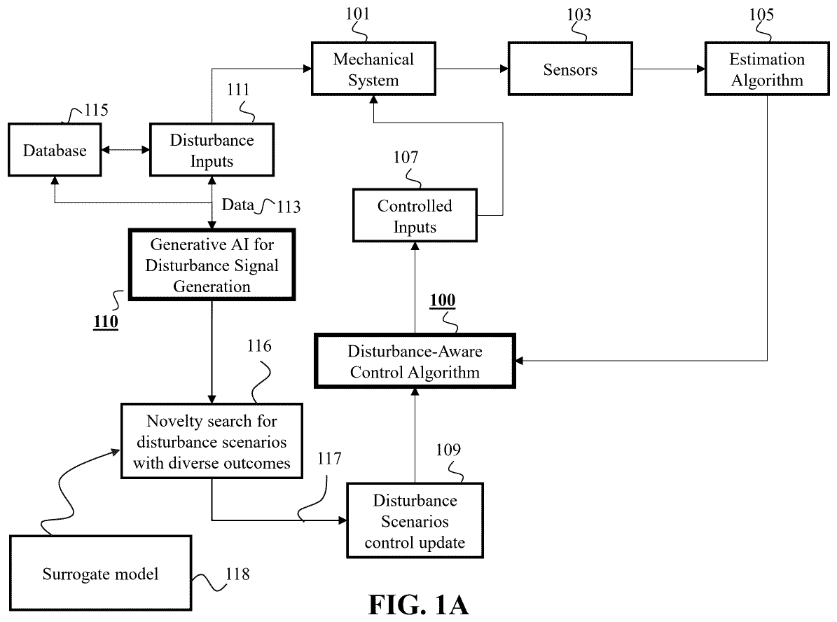

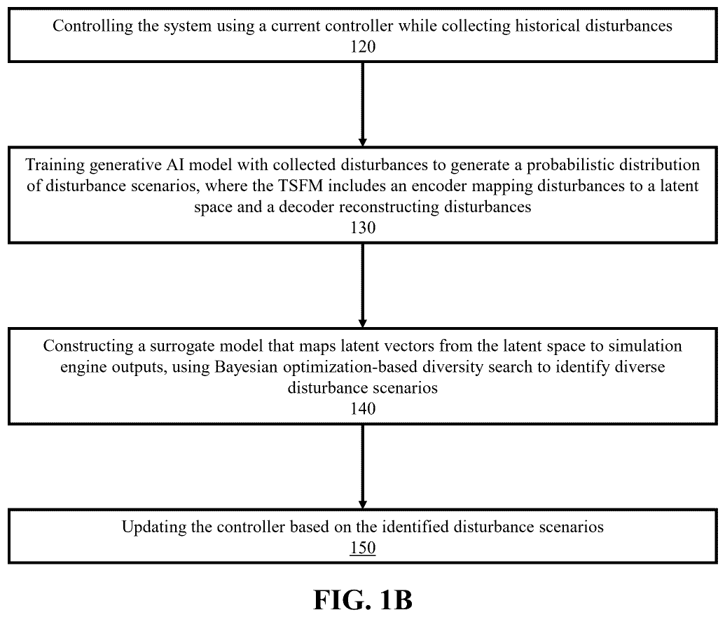

FIG. 1A and FIG. 1B illustrates a schematic overview of disturbance-aware control as employed by certain embodiments. These embodiments implement an adaptive control framework that integrates real-time sensor data, predictive disturbance modeling, and control updates to enhance the system's ability to operate under a variety of conditions.

The embodiments are designed to control a mechanical system 101, which may be described by a model of its dynamics represented by the equation:

$${x}_{k + 1} = f ( {x}_{k} , {u}_{k} , {w}_{k} ) \qquad ( 1 )$$

where xₖ represents the current state of the system, some components of which may be measured by sensors 103. A state estimation algorithm 105 may be used to derive estimates of the full system state based on these measurements. The vector uₖ represents control inputs 107, which dictate the system's response, while wₖ denotes exogenous disturbances 111 that influence system behavior at time step k.

In one example, mechanical system 101 may be a thermodynamic system regulating energy within a building. In this context, the function ƒ may describe the thermal dynamics of an air-conditioned zone, where the system states xₖ include room air temperature, interior wall surface temperature, and exterior wall core temperature. The control inputs uₖ may correspond to the heating and cooling power of a heat pump, while the disturbance inputs wₖ may include external air temperature, solar radiation, airflow, and internal heat loads resulting from occupant activity and heat-generating appliances.

A disturbance-aware control algorithm 100 is employed to achieve desired operating conditions 109 based on estimated system states, sensor measurements, and disturbance predictions. These disturbance predictions are generated using generative AI 110, which is trained on data sources including real-time disturbance inputs 111 from the mechanical system 101 and historical disturbance data stored in a database 115. The stored data may include previously collected information from the mechanical system itself or alternative sources.

Some embodiments utilize generative AI 110 to perform novelty search 116, which enables the generation of disturbance scenarios 117 that may result in distinct system behaviors. By leveraging these diverse disturbance scenarios 117, the controller responsible for managing the system 101 is updated 109 to support disturbance-aware control 100.

To further enhance adaptability under varying conditions, some embodiments incorporate predictive disturbance modeling through generative AI 110. The generative AI is trained using multiple data sources, including both real-time sensor inputs 111 and historical records retrieved from database 115. The stored records may include disturbances observed in the past as well as synthetically generated scenarios designed to explore a broader range of system behaviors.

In some implementations, a novelty search process 116 is Bayesian optimization-based novelty search employed to systematically explore and identify disturbance scenarios 117 that extend beyond those captured in historical data. Instead of relying exclusively on past observations, this approach generates new disturbances that may lead to previously unobserved system responses. By doing so, these embodiments enable a more comprehensive understanding of system behavior and facilitate adjustments to the control strategy accordingly.

Control 109 is updated in response to these diverse disturbance scenarios 117, allowing the system to adapt to conditions that were not previously encountered. This adaptive process is supported by the disturbance-aware control algorithm 100, which integrates sensor-based state estimation 105, predictive disturbance modeling through generative AI 110, and Bayesian optimization-based novelty search 116. These components work together to refine the controller's response by balancing the exploration of new disturbance conditions while maintaining stable operation.

As used herein, novelty search refers to a class of exploration algorithms designed to identify diverse system behaviors through simulation or experimentation. The ability to uncover a wide range of behaviors is useful in various engineering applications, including material and drug discovery, neural architecture search, reinforcement learning, and robotic navigation. Because the relationship between system inputs and outputs is not always available in closed analytical form, novelty search provides a method for handling model opacity.

In various embodiments, the Bayesian optimization-based novelty search 116 employes a surrogate model 118 that maps latent vectors from the latent space of the tuned generative AI 110 to outputs of a simulation engine simulating the performance of the current controller in controlling the operation of the dynamical system 101 under disturbances corresponding to decoded latent vectors. The surrogate model 118 is constructed using Bayesian optimization-based diversity search 116 to identify a set of disturbance scenarios likely to result in diverse outputs of the simulation engine.

The embodiment depicted in FIG. 1A provides an approach to disturbance-aware control that enables automated disturbance modeling without relying solely on historical data. The inclusion of novelty search introduces additional diversity in disturbance scenarios, allowing the controller to be trained across a wider set of operating conditions. This may result in improved resilience to unforeseen disturbances. By incorporating Bayesian optimization, the system efficiently selects disturbance scenarios for evaluation, supporting computational efficiency while refining control strategies. Since this approach is adaptable, it may be implemented across various types of dynamical systems, including HVAC systems, power grids, autonomous vehicles, and industrial automation, where predictive disturbance modeling and adaptive control provide operational advantages.

For systems where simulation or evaluation is computationally expensive, some embodiments employ a sample-efficient novelty search method inspired by Bayesian optimization principles. This approach models the relationship between inputs and system behaviors using multi-output Gaussian processes (MOGP), enabling the selection of disturbance inputs that maximize a novelty metric while maintaining a balance between exploration and exploitation. By leveraging advancements in posterior sampling techniques and high-dimensional Gaussian process modeling, these embodiments are scalable with respect to both the volume of data processed and the complexity of the input space.

FIG. 1B illustrates a flowchart of a method for controlling the operation of a dynamical system subject to disturbances, in accordance with some embodiments. The method is executed by a processor coupled with stored instructions that, when executed, perform the steps of the method.

The method begins with controlling 120 the system 101 using a current controller while simultaneously collecting historical disturbances experienced during operation. These collected disturbances provide a dataset that captures past system responses and informs subsequent modeling processes.

Next, the method involves training 130 a generative AI model 110 using the collected historical disturbances. This tuning process adapts the generative AI model to generate disturbance scenarios that reflect a broader range of potential disturbances, including both previously observed and newly generated disturbances. The tuned generative AI model includes an encoder that maps input disturbances into a latent space representation and a decoder that reconstructs disturbances from this latent space.

The method then performs novelty search 115 by constructing 140 a surrogate model that establishes a mapping between the latent space of the tuned generative AI model and the outputs of a simulation engine. The simulation engine evaluates the performance of the current controller in managing the dynamical system under disturbances derived from the decoded latent vectors. The surrogate model is developed using Bayesian optimization-based diversity search, enabling the identification of a set of disturbance scenarios 117 that are likely to produce varied system responses.

Next, the method updates 150 the current controller based on the generated disturbance scenarios 117. This update allows the controller to adapt to a wider range of operating conditions, improving its ability to manage disturbances that may not have been previously encountered.

The controller can be updated through several approaches, allowing it to adapt to diverse and previously unobserved disturbance conditions. In some embodiments, the update process involves tuning control parameters in response to the newly identified disturbance scenarios. This may include adjusting gains in a proportional-integral-derivative (PID) controller, modifying weight matrices in a model predictive control framework, or refining hyperparameters in a reinforcement learning-based controller. By optimizing these parameters, the control system can respond more effectively to varying disturbances while maintaining stability and efficiency.

In other implementations, the controller may incorporate an adaptive mechanism that continuously adjusts its parameters based on real-time feedback. By dynamically modifying control laws as new disturbances emerge, the system can maintain reliable performance across changing operating conditions. Some embodiments may also employ robust control techniques, designing the controller to operate effectively under a broad range of uncertainties. This approach ensures that the control strategy accounts for worst-case disturbance scenarios, allowing the system to maintain stability even in unpredictable environments.

Another method for updating the controller involves leveraging machine learning techniques to refine control policies. In some cases, the controller may be improved through supervised learning, where new disturbance scenarios are used to train a predictive model. Neural networks or Gaussian process regressors may be employed to enhance the controller's ability to manage disturbances beyond those previously observed. Alternatively, reinforcement learning-based controllers may undergo re-training or fine-tuning, integrating the newly generated disturbance scenarios into the learning process. This enables the controller to improve its decision-making capabilities over time.

In some embodiments, the controller update process may involve optimizing trade-offs between multiple performance objectives. Techniques such as Bayesian optimization or genetic algorithms may be applied to balance criteria such as energy efficiency, system stability, and response time under diverse disturbance conditions. In cases where multiple strategies are beneficial, a hybrid approach may be used. For instance, a model predictive control framework could be combined with reinforcement learning-based adaptation, allowing the controller to efficiently handle disturbances while reducing computational complexity.

By implementing one or more of these approaches, the controller can be adapted to maintain stable and efficient operation across a wide range of conditions. These updates ensure that the system remains resilient to disturbances that were not previously encountered, supporting improved performance and reliability in dynamically changing environments.

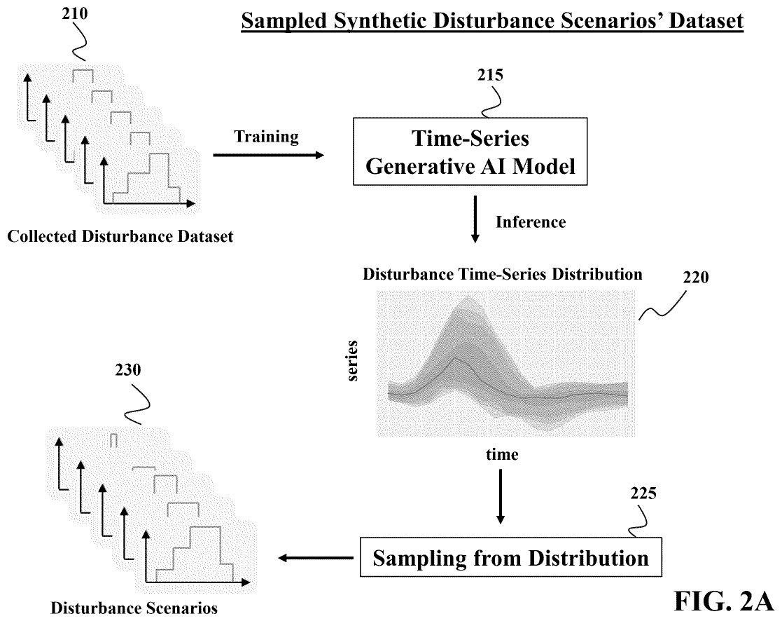

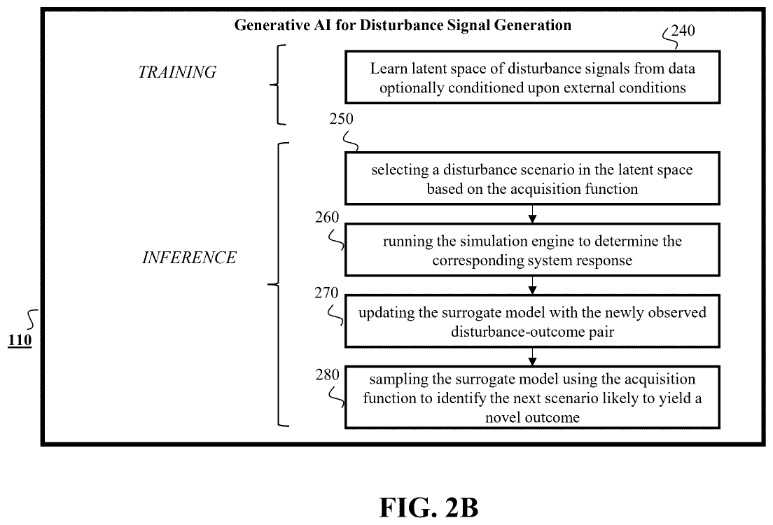

FIG. 2A illustrates the process of training and inference for generating disturbance scenarios using generative AI, in accordance with some embodiments. The collected disturbance dataset 210 includes past disturbances experienced by the system. This dataset provides historical context and serves as a foundation for generating new disturbance scenarios.

To extend beyond previously observed disturbances, the system employs a Time-Series Generative AI Model 220 that learns patterns within the dataset. The model undergoes a training phase 225, where it refines its ability to encode disturbance characteristics and generate new disturbance scenarios based on learned distributions. The advantage of this approach is that it allows the model to create disturbance conditions that are not limited to past observations but instead capture a broader range of possible disturbances.

Following training, the tuned model 215 enters the inference phase, where it samples 225 from the learned distribution 220 to generate new disturbance scenarios 230. These generated disturbances may be compiled into the Sampled Synthetic Disturbance Scenarios Dataset, which includes both historical disturbances and newly synthesized ones. This dataset is useful for evaluating and improving system robustness by testing responses to a wider variety of potential disturbances.

The Generative AI for Disturbance Signal Generation facilitates this process by providing a structured way to explore disturbances and their potential impact on the system. The disturbance scenarios generated through this approach contribute to refining control strategies by allowing systems to anticipate and adapt to a diverse set of conditions.

FIG. 2B illustrates a process for generating disturbance scenarios using a Bayesian optimization-based diversity search, in accordance with some embodiments. The approach begins with the collection of at least partial observations of disturbance signals. These observations provide real-time data about disturbances affecting the system. Using this data, the system learns 240 the latent space of disturbance signals, which serves as a structured representation of disturbance characteristics. By organizing disturbances in this way, the system can more efficiently explore variations that might not have been previously observed.

Tuning a generative AI model for disturbance scenario generation begins with collecting and preprocessing historical disturbance data. This data provides the foundation for training the model by capturing variations in disturbances under different system conditions. Once gathered, the data is normalized and structured to maintain temporal dependencies, ensuring the model can learn meaningful patterns.

Selecting an appropriate model architecture include options such as Variational Autoencoders (VAEs) for structured latent space learning, Generative Adversarial Networks (GANs) for capturing complex distributions, or transformer-based models for handling long-range dependencies. The training process involves an encoder compressing input disturbances into a latent space and a decoder reconstructing disturbances from this representation, guided by loss functions that ensure accuracy and regularization.

For example, in some embodiments, the tuned generative AI model includes an encoder that maps input disturbances into a latent space and a decoder that reconstructs disturbances from this latent space. The tuning process is used to refine the latent space, allowing for more efficient sampling of disturbance scenarios.

Fine-tuning the model enhances its ability to generate realistic and diverse disturbance scenarios. This phase involves supervised or unsupervised techniques depending on data availability. If labeled disturbance types are accessible, supervised fine-tuning adjusts model weights to align with known categories. Otherwise, self-supervised learning can be employed to improve feature extraction from unlabeled data.

Some embodiments recognize that performing a novelty search requires constructing a surrogate model that connects disturbance scenarios with the system's outcomes under those disturbances. This surrogate model facilitates the exploration of a diverse range of scenarios. However, rather than directly building a model that links disturbance scenarios to outcomes, a more efficient approach is to develop a model that connects the latent space of the scenarios to the outcomes corresponding to the simulated operation of system 101. This approach leverages the decoding of latent representations to provide a structured and computationally efficient means of scenario exploration.

To ensure that the generated disturbance scenarios are sufficiently diverse, the method incorporates a novelty metric. This metric measures the diversity of each disturbance scenario by computing its average distance to the k-nearest neighbors in the outcome space. A higher novelty score suggests that a given scenario produces an outcome that is significantly different from previously observed system responses. This approach encourages the discovery of underrepresented behaviors, ensuring that the disturbance-aware control system is exposed to a wider range of potential conditions.

To refine this selection process, the system employs an acquisition function to select disturbance scenario. This acquisition function is designed to prioritize disturbance scenarios that are likely to generate unobserved or underrepresented system behaviors. By doing so, the method improves sample efficiency by directing computational resources toward scenarios that are most valuable for expanding the system's response capabilities. Instead of evaluating all possible disturbances indiscriminately, the acquisition function ensures that each newly selected disturbance contributes to a broader understanding of potential system outcomes.

Some embodiments use of a multi-output Gaussian process (MOGP) surrogate model. This model establishes a relationship between the latent space of the tuned time-series foundational model (TSFM) and the outcome space of the simulation engine. By employing a surrogate model, the system can approximate the effects of disturbances without requiring direct simulations for every possible scenario, thereby reducing computational overhead. This predictive capability allows the system to efficiently identify scenarios that warrant further exploration.

The surrogate model is continuously refined through an iterative process that enhances its accuracy over time. In each iteration, the method selects 250 a disturbance scenario from the latent space based on the acquisition function. The selected scenario is then evaluated 260 through a simulation engine to determine its corresponding system response. The resulting data is used to update 270 the surrogate model, improving its ability to predict future outcomes. The acquisition function is then applied again to sample 280 new scenarios that are likely to yield novel system behaviors. By iteratively updating the surrogate model in this manner, the system progressively enhances its ability to identify disturbances that lead to diverse and meaningful variations in system response.

Through this structured approach, FIG. 2B illustrates how a Bayesian optimization-based diversity search, supported by a novelty metric, an acquisition function, and a surrogate modeling framework, enables the efficient discovery of disturbance scenarios. By strategically selecting and evaluating disturbances, the method improves system adaptability and ensures robust performance under a wide range of conditions.

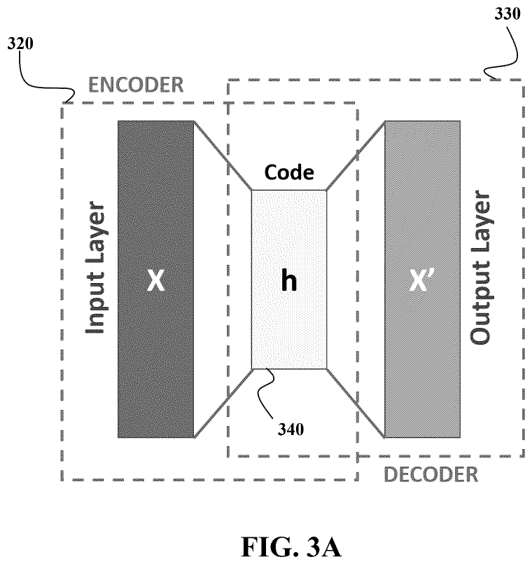

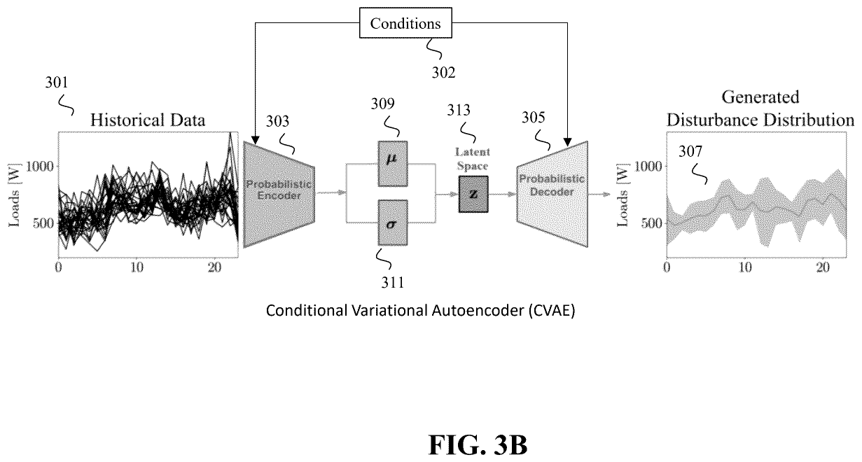

FIG. 3A illustrates a schematic of a time-series generative AI model comprising a general encoder-decoder architecture in accordance with some embodiments. In this model, the encoder 320 maps input disturbance sequences into a compact latent space 340, capturing the temporal structure and variability of the disturbance signals in a lower-dimensional representation. The decoder 330 then reconstructs disturbance signals from this latent representation, enabling the generation of new, realistic disturbance scenarios.

This encoder-decoder structure supports both training, by learning the underlying distribution of historical disturbances, and inference, by synthesizing new disturbance scenarios through sampling from the latent space 340. The time-series generative AI model may be implemented using various architectures, including: a Time-Series Foundational Model (TSFM), which may leverage attention-based mechanisms (e.g., transformers) to capture temporal dependencies; a Conditional Variational Autoencoder (CVAE), which models a conditional probabilistic distribution over the latent space to enable generation of diverse disturbance signals conditioned on contextual variables; and/or a time-series diffusion model, which progressively transforms noise into realistic disturbance sequences through learned denoising processes.

By leveraging the encoder 320 and decoder 330 connected via latent space 340, the model supports structured, sample-efficient exploration of disturbance scenarios critical for downstream tasks such as Bayesian optimization-based diversity search and disturbance-aware control.

FIG. 3B shows a schematic of conditional variational autoencoders (CVAEs) employed by some embodiments to provide a mapping between the latent and the original spaces. The CVAE models the disturbance sequence W≡W_{[0,T]}:==(w₀, . . . , w_{T}) over a time span [0, T], optionally conditioned on an environmental variable c∈[0, 1]ⁿ^{_{c}} 302 which captures the conditions for which disturbance inputs may change in structure, frequency, or other signal characteristics. In embodiments controlling air-conditioning systems, condition c includes seasons, workday vs. weekend, average diurnal temperature, humidity, and/or average solar radiation, geographical location (when considering multiple buildings).

Various embodiments use a probabilistic deep learning method that learns a latent space by encoding disturbance signal data; this latent space can be interpreted as a conditional probability distribution: sampling which, one can obtain disturbance signals by decoding. The CVAE includes an encoder 303 that compresses data signals W 301, given conditional inputs c 302, to a latent representation z 313 in a latent space within [symbol] , and a decoder 305 that is trained to reconstruct the data from the learned latent representation.

The generative model is specified by the distribution π_{θ}(W|z, c) where z is sampled from a latent prior distribution π(z) and θ are the encoder weights. This implicitly specifies the conditional distribution:

$$π ( W \vert c ) = \int π ( W \vert z , c ) π ( z ) dz .$$

The learning objective is to maximize the expected log-likelihood, i.e.,

$${max}_{θ} E [ log {π}_{θ} ( W \vert c ) ] .$$

However, this implicit conditional distribution is generally intractable, which motivates the introduction of a variational posterior q_{φ}(z|W, c) that approximates the actual posterior; ¢ are the decoder weights. This q_{φ} is utilized in a variational lower bound of the expected log-likelihood, also known as the evidence lower bound (ELBO)

$$E [ log {π}_{θ} ( W \vert c ) ] \geq E [ log {π}_{θ} ( W \vert z , c ) + KLD ( {q}_{ϕ} ( z \vert W , c ) \vert \vert π ( z ) ) ] .$$

The parameters (θ, φ) of the CVAE are jointly optimized to maximize the ELBO. Note that the variational posterior is typically parameterized as a conditional Gaussian:

$${q}_{ϕ} ( z \vert W , c ) = 𝒩 ( z ; {μ}_{ϕ} ( W , c ) , {\sum }_{ϕ} ( W , c ) ) ,$$

with the mean vector μ_{φ} 309 and diagonal covariance matrix Σ_{φ} 311 given by parametric functions of (x, s). With the typical assumption of a latent prior distribution being the standard Gaussian distribution, the KLD term in ELBO is readily tractable and differentiable.

The variational posterior can be viewed as an encoder that induces a probabilistic map from W to a latent representation z, conditioned on c. The generative model can be viewed as a decoder that recovers likelihoods for W, conditioned on c, from a sampled latent representation z. This decoder can also be parameterized as a conditional Gaussian, where the mean vector is a parametric function of (z, c) and the covariance is the identity matrix. This simplifies the first term of the ELBO in to be essentially a negative reconstruction loss, i.e., shift-scale of mean-square error (MSE).

Given a trained VAE, the decoder can be used to generate synthetic data 307 by sampling from the latent variables, π_{θ}(W|z, c). This is done by drawing a latent vector z from its prior distribution, and subsequently, for a given c, employing the generative model to specify the distribution π_{θ}(W|z, c) from which the synthetic data should be sampled.

However, the deep generative decoder model 305 is trained offline from the training data of measured disturbances without consideration of the current partially observed disturbances acting on the mechanical system. To address the partial observations, the embodiments use the deep generative decoder model to determine a conditional probabilistic distribution of the latent representations of the disturbance conditioned on the partial observations of the disturbance.

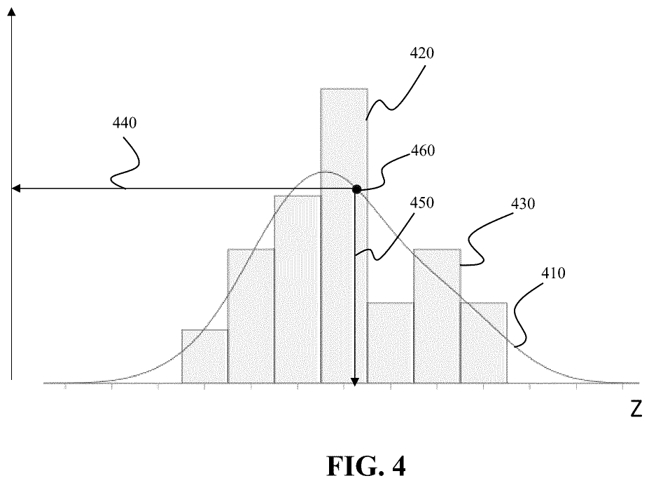

FIG. 4 shows a schematic of an exemplary conditional probabilistic distribution of the latent representations according to some embodiments. The conditional probabilistic distribution 410 of the latent representations of the disturbance is determined based on a comparison of corresponding portions of a set of latent representations decoded by the deep generative decoder model with the partial observations of the disturbance. For example, in the example of FIG. 4, decoding of the latent samples from area 420 are more likely to fit the partial observations than decoding of the latent samples from area 420.

Some embodiments sample 460 the conditional distribution 410 to produce a latent sample 450 and its probability 440 to represent the partial observations. The decoding of the latent sample 450 and its probability 440 are used by SMPC for the stochastic control.

Different embodiments use different techniques to determine the conditional distribution 410. For example, some embodiments determine the conditional probabilistic distribution of the latent representations of the disturbance based on a comparison of corresponding portions of a set of latent representations decoded by the deep generative decoder model with the partial observations of the disturbance.

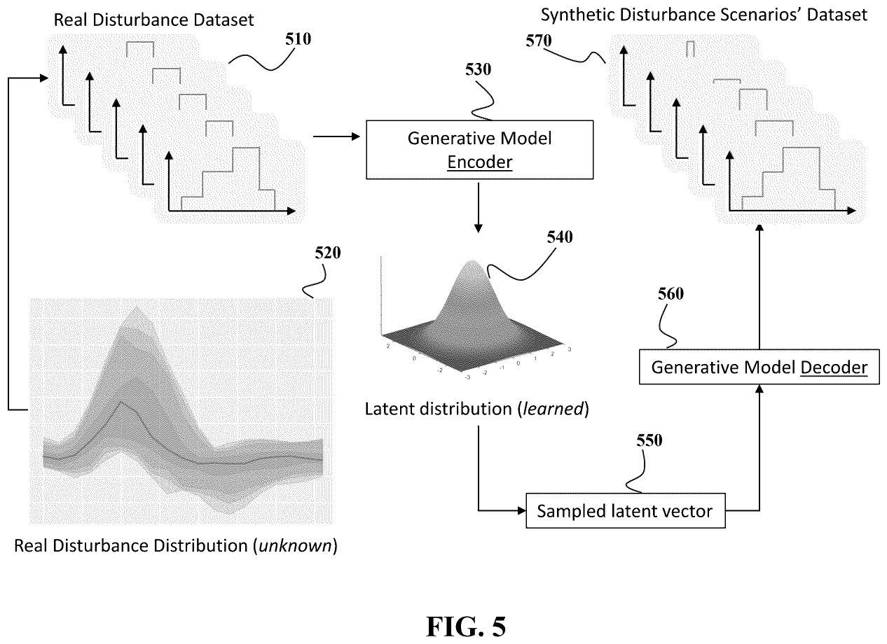

FIG. 5 illustrates a structured approach to modeling disturbances using generative AI, incorporating real disturbances, a learned latent space, and synthetic disturbance scenarios to support system simulation and adaptation. The process begins with real disturbances 510, which are collected from actual system operations. These disturbances reflect various external influences, environmental conditions, and operational variations. They provide useful information for training the generative AI model to recognize patterns in how disturbances affect the system over time.

Since the unknown disturbance distribution 520 is not explicitly defined, disturbances may arise in ways that are not fully captured by past observations. To address this, the system organizes disturbances into a latent space 540, which serves as a structured representation that simplifies the analysis and generation of new disturbance scenarios. This transformation is achieved through an encoder 530, which processes real disturbances and maps them into a lower-dimensional space. The latent space allows for a more manageable representation of disturbances while retaining their key characteristics.

Once the latent space is established, it enables the generation of synthetic disturbances by sampling latent vectors 550. These latent vectors represent variations of disturbances that may extend beyond those previously observed. The decoder 560 reconstructs these disturbances back into the original disturbance space, producing a dataset of synthetic disturbance scenarios 570. This dataset supports the exploration of a broader range of disturbances, offering insights into how the system might behave under different conditions.

A structured latent space also helps in developing a surrogate model, which connects the latent vectors 550 to the outcomes of corresponding synthetic disturbances 570. Instead of linking disturbances directly to system responses, the surrogate model operates within the latent space, making it possible to predict system behavior with fewer simulations. The synthetic disturbances 570, generated from the latent vectors, are used in system simulations to assess their effects. These simulations refine the surrogate model, improving its ability to represent different disturbance conditions while managing computational complexity.

This approach offers several advantages. It provides a way to explore disturbances efficiently by leveraging the latent space to focus on meaningful variations. It also supports adjustments to control strategies, as the surrogate model helps anticipate system responses to a range of disturbances. Additionally, this structure allows for flexibility in generating and testing disturbances beyond those seen in training, helping the system maintain reliable operation across different scenarios. By integrating real disturbances, latent space learning, and surrogate modeling, the system is better equipped to adapt to evolving conditions while making efficient use of computational resources.

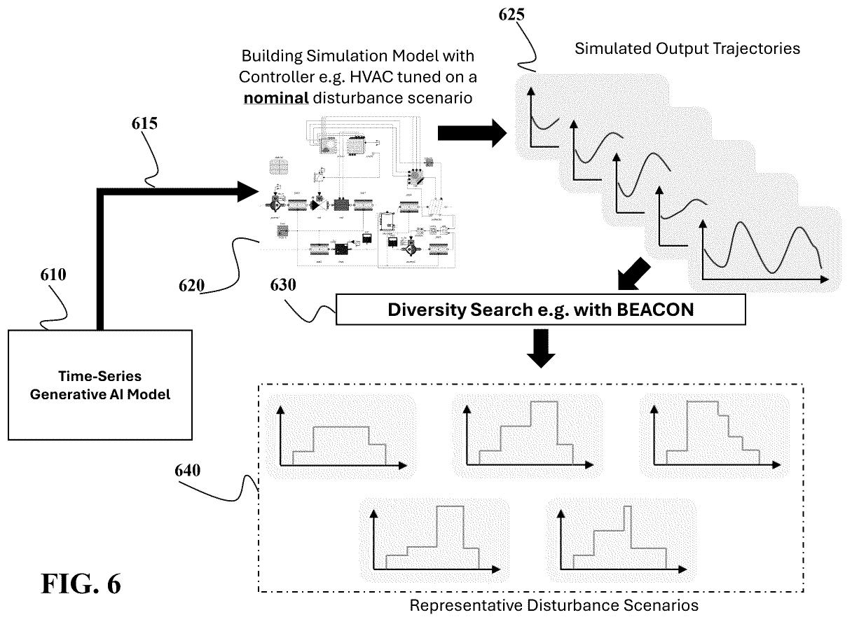

FIG. 6 illustrates a method for selecting disturbance scenarios that lead to diverse performance outcomes in a controlled system, making use of novelty search in accordance with some embodiments. The process begins with a tuned generative AI model 610, such as a time-series foundational model that has been adapted based on previously measured disturbance scenarios. This model generates a set of disturbance scenarios 615, which represent potential variations in the disturbances that may affect system performance. By leveraging the trained AI model, the system is able to produce disturbance scenarios that extend beyond past observations, providing a broader range of potential conditions for evaluation.

Once the disturbance scenarios are generated, they are submitted to a simulation engine 620, where they are used to model the behavior of the machine 101 under these disturbances. The simulation produces outcome trajectories 625, which describe how the system performs under different disturbance conditions. These outcomes can depend on various performance metrics, such as energy efficiency, stability, or operational robustness, though the approach is flexible enough to accommodate different criteria based on the specific application. The simulated outcomes provide a structured way to assess how different disturbances influence the system's behavior.

With a set of paired disturbance scenarios and their corresponding outcomes, the method then applies diversity search 630, incorporating Bayesian optimization to refine a surrogate model that connects disturbances with their respective outcomes. The goal of this optimization process is to identify disturbance scenarios 640 that lead to diverse, meaningfully different, system responses. Instead of simply selecting disturbances that maximize or minimize a specific performance metric, this approach prioritizes scenarios that provide new insights into system behavior, helping to explore a wider range of possible operational conditions.

The selected disturbance scenarios are then used to refine the system's control strategy. Specifically, they help in updating a nominal controller 620, originally used for simulation, into a disturbance-aware controller 100. By incorporating insights from a variety of disturbance scenarios, the controller becomes better equipped to manage unpredictable conditions. This process enhances adaptability while maintaining efficiency, as the surrogate model reduces the number of full-scale simulations required to achieve meaningful results.

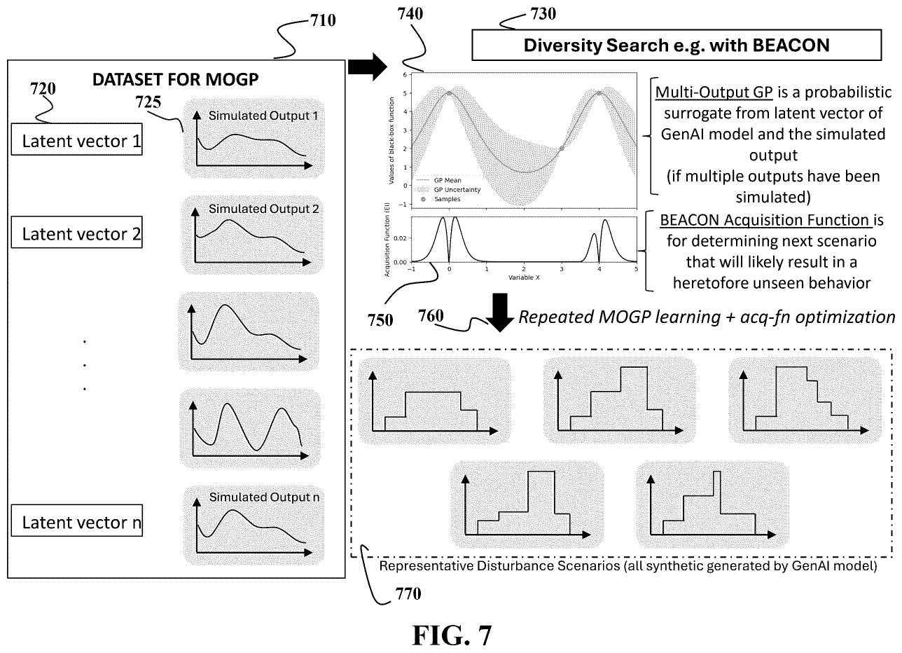

FIG. 7 illustrates a method used in some embodiments for selecting a set of disturbance scenarios that correspond to diverse system performance outcomes. The approach makes use of a dataset 710, which contains pairs of latent vectors 720 representing disturbance scenarios along with their corresponding performance outcomes 725 from the system 101. By structuring the data in this way, the method allows for a systematic exploration of disturbance scenarios that may lead to a variety of system responses, providing insights that could be useful in refining control strategies.

In some embodiments, a surrogate model 740 is employed to map the relationship between disturbance scenarios and their outcomes. An example of such a model is a Multi-Output Gaussian Process (MOGP), which serves as a probabilistic surrogate connecting the latent space of the generative AI model with simulated system outputs. This approach is particularly beneficial when multiple performance metrics are considered, as it enables the model to capture dependencies between different outcomes efficiently. The use of a surrogate model provides an advantage by reducing the need for extensive simulations, which can be computationally expensive.

To enhance the selection of disturbance scenarios, some embodiments apply the BEACON Acquisition Function 750, which is designed to identify disturbance conditions that may lead to novel or previously unexplored system behaviors. Through an iterative sampling process 760, the model selects scenarios that are expected to offer new insights into system performance. These scenarios are then evaluated using a simulation engine, and the newly observed pairs of disturbance scenarios and outcomes are used to refine the surrogate model 740. This iterative approach supports a more efficient exploration of disturbance conditions, as it continually improves the model's ability to predict how different disturbances may influence the system.

By applying this method, some embodiments select a final set of representative disturbance scenarios 770, which serve as a useful reference for improving system robustness. The advantage of this approach is that it allows control strategies to be refined based on a diverse range of disturbance conditions, rather than being limited to historical disturbances or predefined test cases. As a result, controllers may be adapted to better handle unexpected conditions, supporting improved resilience and adaptability. By integrating generative AI, Bayesian optimization, and surrogate modeling, this method offers a structured and computationally efficient way to explore a broad range of potential disturbances while minimizing the need for exhaustive simulations.

### Exemplary Embodiments—BEACON: A Bayesian Optimization Inspired Strategy for Efficient Novelty Search

Modern engineering systems often exhibit complex input-output relationships that are difficult to model explicitly. In many cases, these systems can be represented as black-box functions, where system inputs, denoted as x, map to outcomes f(x) in an outcome space O. Various computational approaches have been developed to optimize system performance based on predefined objective functions. These include derivative-free search methods, such as simplex-based algorithms (e.g., Nelder-Mead), meta-heuristic population-based algorithms (e.g., particle swarm optimization), and surrogate-based optimization techniques (e.g., Bayesian optimization). However, while these methods are well-suited for optimizing a system toward a specific goal, they may not fully capture the range of possible system behaviors. In certain applications, instead of seeking an optimal solution, it is beneficial to systematically explore the diversity of possible outcomes that the system can produce under different conditions.

Some embodiments address this challenge by employing novelty search, a method designed to explore a broad range of behaviors rather than simply optimizing for a predefined objective. For example, consider a forced Duffing oscillator, where the system's behavior depends on external parameters and forcing conditions. The solutions to this system can exhibit a variety of behaviors, including chaotic, periodic, quasi-periodic, or asymptotically stable dynamics. A conventional optimization approach, such as minimizing or maximizing Lyapunov exponents, may only identify specific behaviors (e.g., stability or chaos) while overlooking intermediate behaviors. Additionally, conventional methods may become trapped in local optima, limiting their ability to explore a broader spectrum of system responses. Novelty search overcomes these limitations by shifting the focus from optimization to systematic exploration, allowing for a more comprehensive understanding of how the system behaves across different inputs.

Instead of optimizing for a predefined outcome, novelty search modifies system inputs x and evaluates the corresponding system responses f(x) using a novelty metric. This metric measures the distinctiveness of an observed outcome relative to previously encountered system behaviors. Some embodiments implement novelty search in various scientific and engineering applications, such as material discovery, drug design, and reinforcement learning, where exploring a broad range of behaviors is advantageous. Traditional novelty search methods often rely on evolutionary algorithms, such as genetic algorithms (GAs) and particle swarm optimization (PSO), which iteratively evolve candidate solutions to maximize diversity. However, these methods are often computationally expensive, requiring a large number of function evaluations. Some embodiments instead apply Bayesian optimization (BO) principles to enhance the efficiency of novelty search, reducing the number of system evaluations while maintaining a high degree of behavioral exploration.

Some embodiments utilize Gaussian Process (GP) surrogate models to approximate the relationship between system inputs and outputs. Unlike conventional Bayesian optimization methods that seek to optimize an objective function, these surrogate models are designed to explore a diverse outcome space defined by the user. For instance, in the context of material discovery, the outcome space may include multiple criteria such as material stability, synthesizability, and efficiency. A Bayesian exploration framework, referred to in some embodiments as BEACON (Bayesian Exploration Algorithm for Outcome Novelty), is applied to efficiently identify novel system behaviors. The BEACON framework incorporates a Thompson sampling-based acquisition function, which balances exploration and exploitation, accounts for stochastic noise, and enables efficient gradient-based optimization.

Some embodiments extend this approach to high-dimensional search spaces by incorporating Bayesian sparsity-inducing priors and domain-specific adaptations for applications such as computational chemistry. Experimental results on synthetic and real-world datasets demonstrate that BEACON achieves improved novelty search efficiency, identifying a broader range of behaviors while reducing computational overhead. Example applications include the discovery of metal-organic frameworks (MOFs) for clean energy storage and molecular candidates for pharmaceutical research, where systematically uncovering new material properties or molecular structures is beneficial.

By leveraging Bayesian optimization for novelty search, some embodiments provide an efficient and scalable solution for exploring complex engineering systems. This approach allows for systematic discovery of diverse behaviors, improving the ability to anticipate previously unobserved outcomes and adapt control strategies accordingly. The disclosed methods are particularly useful in domains where system responses are unpredictable and where a broader understanding of the possible behaviors can lead to more robust decision-making.

In novelty search, the goal is to encourage exploration by rewarding inputs that exhibit unique behaviors compared against previously evaluated inputs. Various embodiments consider the behavior of a system to be characterized by a vector-valued black-box function ƒ: χ→ [symbol] with ƒ=(ƒ⁽¹⁾, . . . , ƒ⁽ⁿ⁾) that maps an admissible input space χ⊂ [symbol] to a possibly multi-output outcome space [symbol] ⊂ [symbol] that are both compact. We assume that neighboring values in outcome space share similar behaviors. To express this mathematically, we define a discrete (finite) behavior space [symbol] that is an E-cover of [symbol] , i.e., for some ϵ>0, ∀y∈ [symbol] , ∃y′∈ [symbol] such that ∥y−y′∥≤ϵ.

Define a distance metric ρ: [symbol] × [symbol] → [symbol] on pairs of outcomes. Then a novelty score ζ is defined by ζ(x)=ρ(ƒ(x), [symbol] ), where [symbol] ⊆ [symbol] is an archive of previously observed outcomes against which novelty of x is being measured. In general, we formulate a novelty score as

$$ζ ( x ) = A ( \{ ρ ( f ( x ) , {o}^{′} ) \vert {o}^{′} ∈ {𝒪}^{′} \} ) , \qquad ( 1 )$$

where A: [symbol] → [symbol] is an accumulation operator such as the mean or maximum, and the argument of A represents the set of distances from ƒ(x) to each behavior in the archive [symbol] .

An example of ζ using the k-nearest neighbors metric is

$${ζ}_{kNN} ( x ) = \frac{1}{k} {\sum }_{i = 1}^{k} ‖ f ( x ) - f ( {x}_{i} ) ‖ . \qquad ( 2 )$$

Here, the accumulator A would be the expectation operation, ρ the Euclidean distance defined on [symbol] , and

$${\{ {x}_{i} \}}_{i = 1}^{k}$$

denote the K-nearest neighbors to x with respect to values they induce in the outcome space through ƒ.

Some embodiments are based on understanding that population-based NS algorithms can be effective at discovering diverse function behavior by keeping populations with high k-nearest novelty score and perform mutations to generate possibly novel function behavior. However, these algorithms typically require large population sizes, and therefore, an exorbitant number of function evaluations (NFEs), which is not favorable for the case that function evaluation is expensive. In comparison, BO is known to have high sample efficiency in black-box settings.

### Bayesian Optimization

BO is a sequential decision-making strategy to efficiently find a global optimum x*=argmin_{x∈χ}ƒ(x) for an expensive-to-evaluate black-box function ƒ, where X represents the admissible search space. Classical BO performs the following two steps ad infinitum, or until a predefined sampling budget is exhausted: (1) Constructing uncertainty-aware (probabilistic) surrogate models based on previously sampled data pairs {(x, y)} where y is a possibly noisy observation of ƒ(x) and (2) Optimizing an acquisition function (AF) that provides some measure of how valuable a future point is to sample by balancing the exploration-exploitation trade-off during the BO search process.

Exemplar acquisition functions include upper confidence bound (UCB), expected improvement (EI), and Thompson sampling (TS). TS is a randomized approach for sequential decision making under uncertainty and has been shown to provide strong empirical performance in BO. TS works by selecting argmin_{x∈χ}g(x) as the next sample location where g is a posterior realization of the probabilistic surrogate model.

Gaussian process (GP) models are effective choice of surrogate model in BO. The underlying assumption in GPs is that the outputs at any finite collection of inputs can be modeled by a multivariate Gaussian distribution. This implies that a GP prior is fully specified by a prior mean function μ(x) and a prior kernel function κ(x, x′) that specifies the covariance of any two function values ƒ(x) and ƒ(x′) for any x, x′∈χ. The kernel encodes key information related to the underlying properties of the function (such as smoothness and stationarity) and so is problem-dependent. The methods of various embodiments can be generally applied to any valid kernel function, though one should only expect good performance in cases where the kernel is well-aligned to the problem at hand. Since the optimal kernel a priori can be unknown, some embodiments may use hyperparameters in the kernel that can be tuned given available data.

Given a GP prior, some embodiments can infer (predict) the function value ƒ(x) at an arbitrary text point x∈χ given a set of N function observations denoted by

$$𝒜 = {\{ ( {x}_{i} , {y}_{i} ) \}}_{i = 1}^{N}$$

where yᵢ=ƒ(x)+ηᵢ and ηᵢ∈ [symbol] (0, σ²) is a noise term with mean zero and variance σ². Conditioned on [symbol] , the posterior remains a GP with the following mean and kernel functions

$${μ}_{𝒜} ( x ) = μ ( x ) + {κ}_{𝒜}^{T} ( x ) {\tilde{K}}_{𝒜}^{- 1} ( y - {μ}_{𝒜} ) , \qquad ( 3 )$$

$${κ}_{𝒜} ( x , {x}^{′} ) = κ ( x , {x}^{′} ) - {κ}_{𝒜}^{T} ( x ) {\tilde{K}}_{𝒜}^{- 1} {κ}_{𝒜} ( {x}^{′} ) ,$$

where y=[y₁, . . . , y_{N}]^{T}, [symbol] =[μ(x₁), . . . , μ(x_{N})]^{T}, [symbol] (x)∈ [symbol] is the vector of covariance values between the test input x and the observed inputs in [symbol] , and [symbol] = [symbol] +σ²I_{N} with [symbol] ∈ [symbol] denoting the covariance matrix between all observed inputs in [symbol] .

### Bayesian Exploration for Outcome Novelty Search

Recall that [symbol] is the outcome space, and [symbol] is the discrete set of unique behaviors whose cardinality (or a lower bound) | [symbol] | is known. Suppose φ: [symbol] [symbol] [symbol] be the function that maps an outcome of the system to a specific behavior. In Bayesian novelty search, we are interested in identifying inputs that cover as much of the behavior space [symbol] as possible. Since each evaluation of ƒ is expensive, we want to uncover a diverse range of behaviors over a finite and discrete sample budget

$${\{ x \}}_{t = 1}^{T} .$$

We can also handle the case when the function ƒ is noisy, and therefore a measurement of the outcome function yields yₜ=ƒ(xₜ)+ηₜ. We assume that the noise ηₜ~ [symbol] (0, σ²Iₙ) is isotropic Gaussian with zero-mean and standard deviation σ∈ [symbol] .

In order to ascertain our coverage of the behavior space [symbol] , we define a behavior gap at iteration t by the quantity:

$$B {G}_{t} = 1 - ( \vert \{ φ ( f ( {x}_{1} ) ) , … , φ ( f ( {x}_{t} ) ) \} \vert / \vert ℬ \vert ) .$$

This allows embodiments to measure the fraction of unobserved behaviors in the system. Our objective is to minimize the cumulative behavior gap

$${\sum }_{t = 1}^{T} {BG}_{t} ,$$

or equivalently, maximize the fraction of unique behaviors observed thus far.

Since ƒ is unknown, embodiments may not be able to directly minimize the cumulative behavior gap. Instead, embodiments adopt an intelligent sequential learning strategy inspired by BO. In the general case where ƒ is a multi-output function, a multi-output surrogate modeling approach is necessary. To this end, we model ƒ using a multi-output Gaussian process (MOGP) prior, which is particularly well-suited for problems where ƒ exhibits smoothness properties, such as membership in a reproducing kernel Hilbert space (RKHS). The MOGP enables the construction of a posterior distribution [symbol] (ƒ| [symbol] ) over the true function ƒ, given observed data

$${𝒟}_{t} = {\{ ( {x}_{i} , {y}_{i} ) \}}_{i = 1}^{t} .$$

Critically, the posterior mean and covariance function in the multi-output setting can still be computed analytically. By extending the kernel definition to incorporate the output index as an additional input, i.e., κ((x, j), (x′, j′)), the standard posterior predictive equations for single-output Gaussian processes in (3) remain applicable. In cases where the outputs are independent, the kernel simplifies to a block-diagonal structure, and the MOGP reduces to independent GP regressions for each output.

Examples of the general novelty scores ζ include the novelty score based on nearest neighbors, ζ_{kNN}. Evaluating ζ_{kNN} requires access to the true function ƒ, which is unavailable since ƒ is a black-box function. Furthermore, some embodiments account for the uncertainty in evaluating ƒ, as the observed values φ(y) may differ from the true values φ(ƒ(x)) due to noise η. This discrepancy can lead to inaccuracies in the distance metric ρ, causing it to select spurious neighbors thus making the novelty score sensitive to noise.

Hence, some embodiments use the MOGP surrogate to help overcome these challenges. Given a dataset [symbol] , denote the MOGP posterior by MOGP ( [symbol] , [symbol] ), where [symbol] (x) is the vector-valued mean function and [symbol] (x, x′) is a matrix-valued covariance function with elements. The MOGP serves two key purposes: (i) it filters observation noise by replacing noisy data with surrogate predictions, and (ii) it enables uncertainty-aware decision-making by allowing us to “fantasize” potential realizations of ƒ, for instance, through Thompson sampling [?], which can be performed efficiently.

To incorporate these capabilities, embodiments draw a Thompson sample \hat{ƒ}(x)~MOGP( [symbol] , [symbol] ) from the MOGP posterior conditioned on the data [symbol] collected up to the t-th iteration. Using this sample, define the following acquisition function (to be maximized):

$${α}_{N S} ( x \vert \hat{f} , {𝒟}_{t} ) := \frac{1}{k} {\sum }_{i = 1}^{k} ρ ( \hat{f} ( x ) , {μ}_{{𝒟}_{t}} ( {x}_{i}^{*} ) ) , \qquad ( 4 )$$

which serves as a computationally tractable proxy for the novelty score (2). For a given x, the points

$$\{ {x}_{i}^{⋆} \} ⊂ \{ {x}_{1} , … , {x}_{N} \}$$

are the k nearest neighbors to \hat{ƒ}(x), based on the posterior mean predictions { [symbol] (x₁), . . . , [symbol] (x_{N})} of the MOGP. Closeness is measured using the same distance metric ρ as in (2). By maximizing α_{NS}(x) over the input domain χ, we identify an xₜ₊₁ such that the distance from \hat{ƒ}(xₜ₊₁) to its k nearest neighbors is maximized. This encourages exploration by promoting the discovery of novel behaviors and unseen outcomes. Once xₜ₊₁ is selected, we evaluate ƒ(xₜ₊₁) to obtain yₜ₊₁, update the dataset [symbol] = [symbol] ∪{(xₜ₊₁, yₜ₊₁)}, and repeat the BEACON loop.

To maximize the acquisition function efficiently, embodiments take advantage of gradient-based methods with fast convergence and low memory complexity, such as L-BFGS-B. This is possible by recasting (4) in terms of the sort operator:

$${α}_{N S}^{sort} ( x ) = \frac{1}{k} {e}_{k}^{T} {sort [ ρ ( \hat{f} ( x ) , {μ}_{𝒟} ( {x}_{q} ) ]}_{q = 1 : N} \qquad ( 5 )$$

where eₖ is a vector whose first k entries are equal to 1 and the remaining entries are equal to 0 and sort denotes an operator that sorts the column vector argument in descending order. As discussed in [?], the standard sort operator is continuous and almost everywhere differentiable (with non-zero gradients).

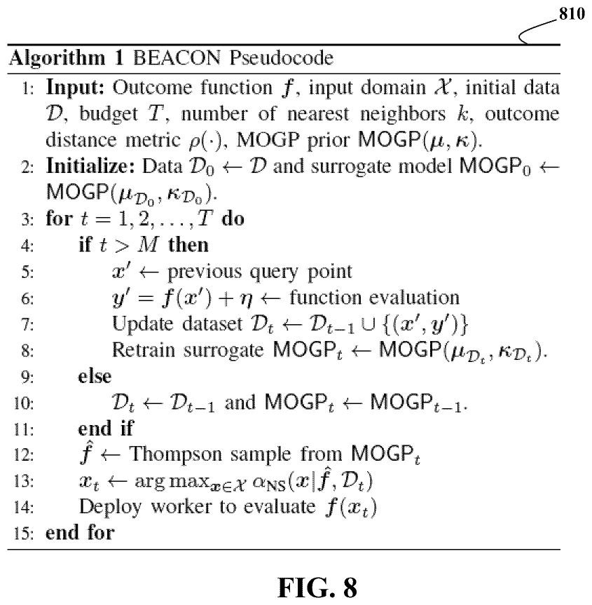

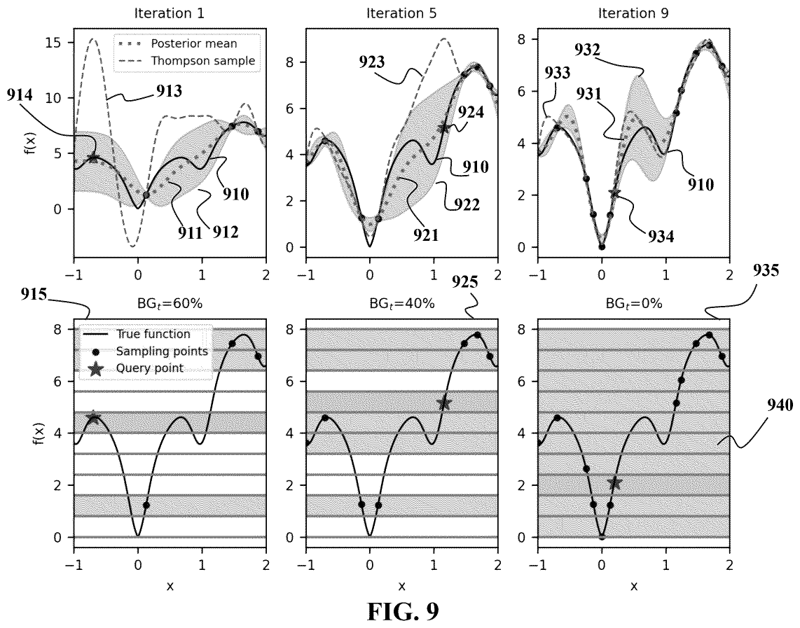

FIG. 8 shows an exemplar pseudocode 810 for the BEACON method employed by some embodiments. FIG. 9 shows an illustration of the iterative BEACON's behavior implemented using the pseudocode 810 of FIG. 8, in accordance with some embodiments. The left, middle, and right columns correspond to BEACON iterations 1, 5, and 9 (the final iteration), respectively. The top row shows the true function 910 of the surrogate model, the evolution of the surrogate model for different iterations including the mean with dotted lines 911, 921, and 931 and confidence interval as blue shaded region 912, 922, and 932, and a single Thompson sample, i.e., dotted lines 913, 923, and 933.

At each iteration, BEACON selects the new query point (depicted by stars 914, 924, and 934) that maximizes our proposed acquisition function α_{NS}. The lower row of plots 915, 925, and 935 depicts the discretization levels used to define different system behaviors with rectangular bands 940: unfilled white bands indicate those behaviors have not yet been discovered, and shaded bands indicate BEACON has discovered that behavior. In this example, there are 10 behaviors, therefore 10 bands.

As the iterations progress, the BEACON consistently finds new behaviors through effective exploration of the outcome space. At the first iteration, 4 out of 10 behaviors have been discovered by the sampling points, resulting in BGₜ=60%. At iteration 9, BEACON can reach BGₜ=0%, indicating that all possible behaviors have been discovered and the algorithm has converged.

### Exemplar BEACON Implementation

In various exemplar implementations, different embodiments use MOGPs having a covariance function κ((x, j), (x′, j′))=δ_{jj,κ}_{ⱼ}(x, x′) where δⱼⱼ, is the Kronecker delta, which implies all outputs are modeled independently. For the synthetic experiments, the GPs have a constant mean function and a covariance radial basis function (RBF) with automatic relevance determination. The exemplar embodiments estimate the GP hyperparameters (and noise variance σ²) using maximum likelihood estimation and the Thompson sampling (TS) method that yields a high-accuracy continuously differentiable realization \hat{ƒ}. In some implementations, the embodiments use python modules, e.g., a PyTorch-based implementation of α_{NS} in 5 that maximize using the SciPy implementation of L-BFGS-B over a random set of multi-start initial conditions.

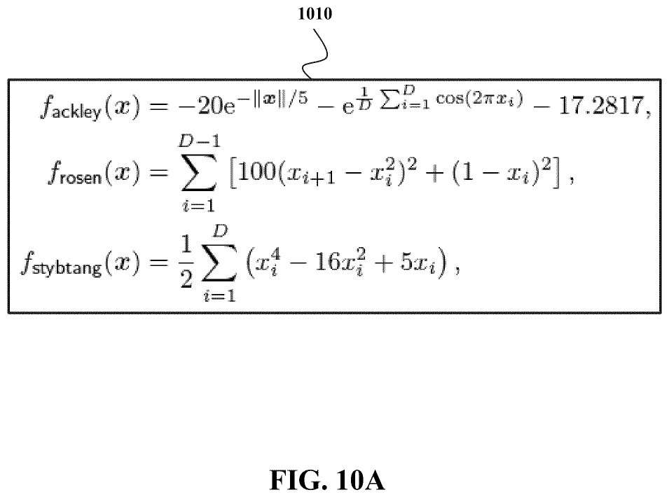

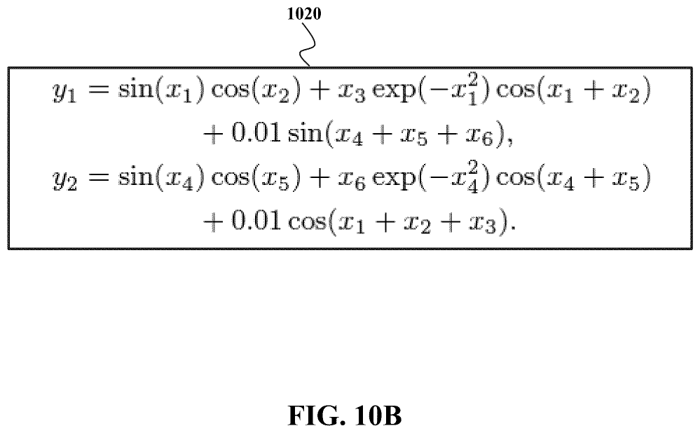

FIG. 10A and FIG. 10B show different examples of the outcome function used to evaluate performance of system 101 according to different embodiments. FIG. 10A shows examples of single-outcome functions 1010, such as the Ackley function, the Rosenbrock valley function, and the Styblinski-Tang function, given by

$${f}_{ackley} ( x ) = - 20 {e}^{- ‖ x ‖ / 5} - {e}^{\frac{1}{D} {\sum }_{i = 1}^{D} cos ( 2 π {x}_{i} )} - 17.2 \; 817 ,$$

$${f}_{rosen} ( x ) = {\sum }_{i = 1}^{D - 1} [ 100 {( {x}_{i + 1} - {x}_{i}^{2} )}^{2} + {( 1 - {x}_{i} )}^{2} ] ,$$

$${f}_{stybtang} ( x ) = \frac{1}{2} {\sum }_{i = 1}^{D} ( {x}_{i}^{4} - 16 {x}_{i}^{2} + 5 {x}_{i} ) ,$$

respectively.

To test BEACON in the multi-output setting, some embodiments use Multi-Output Plus functions 1020 with a long-tail joint distribution, as shown in FIG. 10B. This synthetic function defined over D=6 inputs has two outputs, and has the form

$${y}_{1} = sin ( {x}_{1} ) cos ( {x}_{2} ) + {x}_{3} exp ( - {x}_{1}^{2} ) cos ( {x}_{1} + {x}_{2} ) + 0.01 sin ( {x}_{4} + {x}_{5} + {x}_{6} ) ,$$

$${y}_{2} = sin ( {x}_{4} ) cos ( {x}_{5} ) + {x}_{6} exp ( - {x}_{4}^{2} ) cos ( {x}_{4} + {x}_{5} ) + 0.01 cos ( {x}_{1} + {x}_{2} + {x}_{3} ) .$$

The distribution of outcomes [symbol] based on 10,000 input samples drawn from the space χ=[−5,5]^{D}.

### Exemplar Solutions

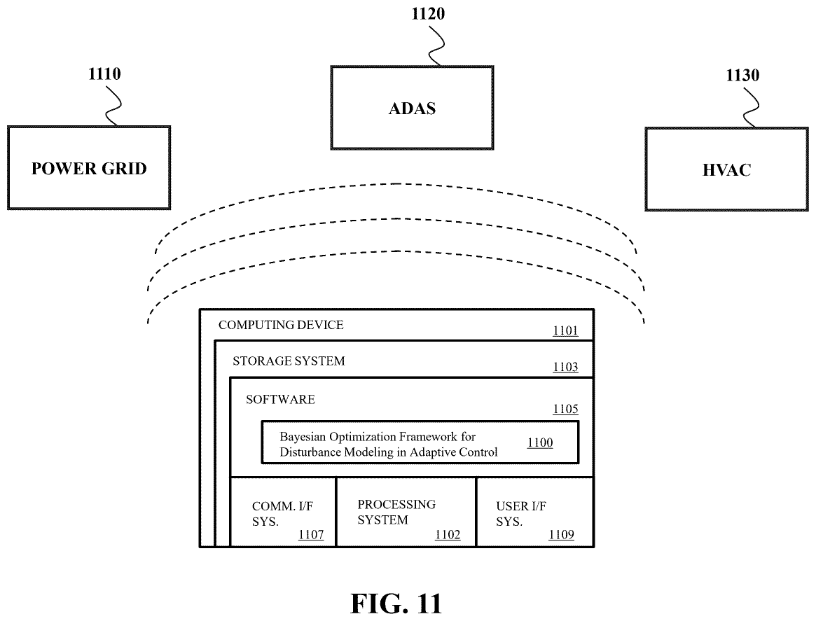

FIG. 11 shows a schematic of computing device 1101 that is representative of any system or collection of systems in which the various processes, programs, services, and scenarios of some embodiments disclosed herein are implemented. Examples of computing device 1101 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 1101 may be implemented as a single apparatus, system, or device or may be implemented in a distributed manner as multiple apparatuses, systems, or devices. Computing device 1101 includes, but is not limited to, processing system 1102, storage system 1103, software 1105, communication interface system 1107, and user interface system 1109. Processing system 1102 is operatively coupled with storage system 1103, communication interface system 1107, and user interface system 1109.

Processing system 1102 loads and executes software 1105 from storage system 1103. Software 1105 includes and implements principles of Bayesian Optimization Framework for Disturbance Modeling in Adaptive Control 1100 described in various exemplar embodiments throughout this disclosure. When executed by processing system 1102, software 1105 directs processing system 1102 to operate as described herein for at least the various processes, operational scenarios, and sequences discussed in the foregoing implementations. Computing device 1101 may optionally include additional devices, features, or functionality not discussed for purposes of brevity.

Referring still to FIG. 11, processing system 1102 may comprise a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, graphical processing units, digital signal processors, application specific processors, and logic devices, as well as any other type of processing device, combinations, or variations thereof.

Storage system 1103 may comprise any computer readable storage media readable by processing system 1102 and capable of storing software 1105. Storage system 1103 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory, and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 may be implemented in program instructions and among other functions may, when executed by processing system 1102, direct processing system 1102 to operate as described with respect to the various operational scenarios, sequences, frameworks, and processes illustrated and/or discussed herein. For example, software 1105 may include program instructions for implementing the sampling, training, and/or rendering processes described herein, as well as the probabilistic guided sampling discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also comprise firmware or some other form of machine-readable processing instructions executable by processing system 1102.

In general, software 1105 may, when loaded into processing system 1102 and executed, transform a suitable apparatus, system, or device (of which computing device 1101 is representative) overall from a general-purpose computing system into a special-purpose computing system customized to perform computer vision processes in an optimized manner. Indeed, encoding software 1105 on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary storage, as well as other factors.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1101 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The inference model trained on multi-modal data using the pseudo-label generation process described above has several practical applications across various domains where audio-visual event understanding is critical. The inference model trained according to the principles of various embodiments can be used, but not limited to, the following applications.

For example, one embodiment of the BEACON for disturbance modeling in adaptive control 1100 is configured to control a power grid 1110 in the presence of challenges due to unpredictable disturbances caused by weather fluctuations and load demand variability. For example, sudden drops in wind or solar power generation, heatwaves increasing electricity demand, and unexpected faults in transmission lines can destabilize the grid. Manually identifying all possible disturbances is impractical because weather conditions and load profiles change dynamically, making it difficult to anticipate every potential disruption.

To address this, the system collects historical disturbances and trains a time-series generative AI model to learn patterns in grid fluctuations. The model generates synthetic disturbance scenarios, including extreme weather events, sudden power plant failures, and demand surges. These scenarios are fed into a surrogate model, which maps them to key performance metrics such as voltage stability, frequency regulation, and energy dispatch efficiency. The surrogate model is optimized using Bayesian optimization-based diversity search, ensuring it captures a broad range of potential grid failures.

A power grid simulation engine, such as a dynamic stability simulator or an electromagnetic transient program (EMTP), evaluates how the grid responds to these disturbances. By simulating responses to generated scenarios, the system identifies weaknesses in current grid control strategies. Bayesian optimization, using a Thompson sampling-based acquisition function, selects the most critical disturbance scenarios for further refinement.

The current grid controller is then modified based on these findings. If the model detects that frequency deviations are severe under specific disturbances, the controller adjusts real-time frequency regulation policies. If voltage instability is identified, the system modifies reactive power compensation and demand-response strategies. Additionally, if a disturbance scenario indicates a high risk of blackouts, the controller updates load-shedding policies or battery storage dispatch strategies to maintain grid stability.

For instance, if the simulation reveals that a sudden drop in wind power leads to frequency instability, the system preemptively increases battery storage discharge and reduces non-critical industrial loads to compensate for the lost power. If an unexpected demand spike during extreme heatwaves is identified as a risk, the controller activates demand-response mechanisms to shift consumption patterns and prevent grid overload. These adjustments are continuously refined as new disturbance scenarios emerge, ensuring the power grid remains stable, resilient, and adaptive to real-world conditions.

Another embodiment directed to ADAS (Advanced Driver Assistance Systems) 1120 is based on the understanding that autonomous driving systems face environmental disturbances that make real-time decision-making complex. Sudden weather changes, erratic human-driven vehicles, unexpected road closures, and sensor malfunctions can compromise safe navigation. Manually programming responses for every possible scenario is infeasible due to the dynamic nature of urban and highway environments.

To handle this, the system collects historical driving disturbances from vehicle sensors, traffic data, and weather conditions. A time-series generative AI model learns patterns in these disturbances and generates synthetic scenarios, such as a pedestrian unexpectedly crossing the road in heavy rain, a highway merging zone with aggressive drivers, or an occluded stop sign due to fog. These scenarios are then mapped using a surrogate model to key ADAS performance metrics, such as trajectory deviation, braking response time, and collision risk estimation. The surrogate model is optimized using Bayesian optimization-based diversity search to capture a wide range of challenging edge cases.

A high-fidelity driving simulation engine, such as CARLA or NVIDIA DRIVE Sim, evaluates how the autonomous system responds to these scenarios. By simulating the vehicle's perception, prediction, and control stack under generated disturbances, the system identifies failure points in current navigation strategies. Bayesian optimization, leveraging a Thompson sampling-based acquisition function, selects the most critical disturbance scenarios that expose weaknesses in the controller's decision-making.

The autonomous navigation controller is then modified based on these insights. If the model detects that the vehicle struggles to react to aggressive lane-cutting behavior, the controller updates its trajectory planning algorithms to maintain a safer buffer distance. If foggy conditions cause delayed LiDAR-based object detection, the controller adapts by increasing reliance on radar and adjusting braking strategies. If a highway merging simulation shows excessive deceleration leading to unsafe traffic interactions, the system refines its lane-changing policies for smoother integration.

For example, if the simulation reveals that icy road conditions cause excessive lateral drift, the controller preemptively adjusts steering torque and reduces acceleration rates to maintain stability. If a sudden pedestrian crossing at night leads to delayed braking, the system enhances sensor fusion strategies, prioritizing thermal imaging or radar-based detection over camera-based vision. These refinements ensure the autonomous navigation system adapts in real time to environmental uncertainties, enhancing safety and resilience across diverse driving conditions.

In another example, some embodiments are based on understanding that Heating, Ventilation, and Air Conditioning (HVAC) systems 1130 should continuously adapt to fluctuating occupant behavior and environmental conditions, such as sudden outdoor temperature changes, varying indoor heat loads, and unpredictable occupancy patterns. Traditional rule-based HVAC controls struggle to optimize comfort and energy efficiency in real time, as manually programming responses for every possible scenario is infeasible.

To address this, the system employing principles of some embodiments collects historical HVAC disturbances, including temperature fluctuations, humidity levels, occupancy patterns, and energy consumption trends. A time-series generative AI model learns these patterns and generates synthetic disturbance scenarios, such as a conference room suddenly reaching maximum occupancy, an unexpected heatwave increasing cooling demand, or a malfunctioning sensor providing incorrect temperature readings. These scenarios are mapped using a surrogate model to key HVAC performance metrics, including thermal comfort index, energy efficiency, air quality, and system response time. The surrogate model undergoes Bayesian optimization-based diversity search to identify critical conditions that affect HVAC performance.

An HVAC simulation engine, such as EnergyPlus or Modelica, evaluates how different control strategies respond to the generated disturbances. By simulating air circulation, heat transfer, and energy consumption under various conditions, the system detects inefficiencies in existing temperature control strategies. Bayesian optimization, leveraging a Thompson sampling-based acquisition function, selects the most critical disturbance scenarios to refine the HVAC controller.

The HVAC controller is then modified based on these insights. If the model detects that the system struggles with sudden occupancy surges, the controller updates its ventilation and cooling load allocation. If outdoor temperature fluctuations cause overcooling or overheating, the controller adjusts setpoints dynamically to balance comfort and energy efficiency. Additionally, if an air quality disturbance scenario suggests inadequate fresh air intake, the controller optimizes ventilation rates to maintain indoor air quality.

For example, if the simulation reveals that a sudden drop in external temperature leads to excessive heating, the controller reduces heating output preemptively while maintaining comfort. If a room remains unoccupied longer than expected, the system automatically lowers HVAC power to save energy. When a large gathering increases CO₂ levels, the controller increases fresh air ventilation to maintain indoor air quality. These adaptive refinements ensure that the HVAC system optimizes temperature control strategies in real time, enhancing comfort, energy efficiency, and air quality while reducing operational costs.

The system employed by various embodiments is not limited to the control of power grids, autonomous navigation, or HVAC systems but is broadly applicable to a wide range of complex dynamical systems. By leveraging historical data, generative AI modeling, Bayesian optimization, and adaptive control mechanisms, the system can be adapted to industrial automation, robotics, aerospace, smart manufacturing, and other cyber-physical systems where resilience to unpredictable disturbances is critical. The framework provides a generalized approach for optimizing decision-making, improving system stability, and enhancing operational efficiency across diverse domains.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the performance of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A method for adaptive control of a mechanical system subject to disturbances, wherein the method uses a processor coupled with stored instructions implementing the method, wherein the instructions, when executed by the processor carry out steps of the method, comprising:
controlling operation of the mechanical system using a current controller while collecting historical disturbances experienced by the system during the operation;
training a time-series generative AI model using the collected historical disturbances to generate a probabilistic distribution of disturbance scenarios, wherein the time-series generative AI model comprises an encoder mapping input disturbances to a latent space and a decoder reconstructing disturbances from the latent space;
constructing a surrogate model that maps latent vectors from the latent space of the time-series generative AI model to outputs of a simulation engine that stimulates performance of the current controller controlling the mechanical system subject to disturbances corresponding to decoded latent vectors, wherein the surrogate model is optimized using Bayesian optimization-based diversity search to identify disturbance scenarios that result in diverse outputs of the performance; and
updating the current controller based on the identified disturbance scenarios.

2. The method of claim 1, wherein the time-series generative AI model is one or a combination of a time-series foundational model (TSFM), a conditional variational autoencoder (CVAE), and a time-series diffusion model tuned using collected historical disturbance data to capture the distribution of structure and dynamics of disturbance scenarios.

3. The method of claim 1, wherein the Bayesian optimization-based diversity search employs a novelty metric to evaluate the diversity of outcomes of disturbance scenarios by computing the average distance to the k-nearest neighbors in an outcome space of the outcomes, wherein a higher novelty score indicates a higher likelihood that a disturbance scenario produces the outcome different from previously observed system responses.

4. The method of claim 3, wherein an acquisition function used in the Bayesian optimization-based diversity search selects disturbance scenarios that maximize novelty by prioritizing inputs expected to generate unobserved or underrepresented system behaviors.

5. The method of claim 4, wherein the acquisition function is a Bayesian optimization-based acquisition function configured to maximize the diversity of disturbance scenarios by selecting latent vectors that optimize the novelty metric.

6. The method of claim 5, wherein the surrogate model is implemented as a multi-output Gaussian process (MOGP) to approximate the mapping between the latent space of the time-series generative AI model and the outcome space of the simulation engine.

7. The method of claim 1, wherein the surrogate model is iteratively refined by:
selecting a disturbance scenario in the latent space using an acquisition function configured to select the disturbance scenario that maximizes novelty by prioritizing inputs expected to generate unobserved or underrepresented performance of the mechanical system control by the current controller subject to the selected disturbance scenario;
executing the simulation engine to determine the corresponding output of the controlled mechanical system and observe a disturbance-outcome pair;
updating the surrogate model using the observed disturbance-outcome pair; and
sampling the surrogate model using the acquisition function to identify the next disturbance scenario likely to yield a novel outcome.

8. The method of claim 1, wherein the Bayesian optimization-based diversity search is implemented using a Thompson sampling-based acquisition function, which selects disturbance scenarios by balancing exploration of unobserved behaviors with exploitation of regions likely to yield high-diversity outcomes.

9. The method of claim 8, wherein the Thompson sampling-based acquisition function is configured to adaptively adjust the balance between exploration and exploitation based on previously observed system responses.

10. The method of claim 1, wherein updating the current controller comprises:
modifying decision-making policies of the current controller based on the identified disturbance scenarios; and
operating the mechanical system using the modified controller.

11. The method of claim 10, wherein updating the current controller comprises one or a combination of:
adjusting control parameters using a reinforcement learning framework that optimizes controller performance based on simulated responses to the identified disturbance scenarios;
implementing a robust control strategy that incorporates worst-case disturbance scenarios to enhance system stability under uncertain conditions specified in the identified disturbance scenarios; and
applying an adaptive tuning mechanism that continuously refines the decision-making policies in response to newly encountered disturbance scenarios.

12. The method of claim 10, wherein the modified controller is applied to a power grid management system to enhance stability under fluctuating demand, renewable energy variability, and grid disturbances.

13. The method of claim 10, wherein the modified controller is applied to an autonomous navigation system, adapting trajectory planning and decision-making to improve system resilience against unpredictable environmental disturbances.

14. The method of claim 10, wherein the modified controller is applied to an HVAC system, optimizing temperature control strategies based on dynamically generated disturbance scenarios representing occupant behavior and environmental variations.

15. A system for adaptive control of a mechanical system subject to disturbances, comprising: a processor coupled with memory storing executable instructions, wherein the instructions, when executed, configure the processor to:
control operation of the mechanical system using a current controller while collecting historical disturbances experienced by the system;
train a time-series generative AI model using the collected historical disturbances to generate a probabilistic distribution of disturbance scenarios, wherein the time-series generative AI model comprises an encoder mapping input disturbances to a latent space and a decoder reconstructing disturbances from the latent space;
construct a surrogate model that maps latent vectors from the latent space of the time-series generative AI model to outputs of a simulation engine, wherein the simulation engine evaluates the performance of the current controller controlling the mechanical system under disturbances corresponding to decoded latent vectors, and wherein the surrogate model is optimized using Bayesian optimization-based diversity search to identify disturbance scenarios that result in diverse system responses;
update the current controller based on the identified disturbance scenarios to produce a modified controller; and
control the mechanical system using control inputs generated by the modified controller.

16. The system of claim 15, wherein the time-series generative AI model is a time-series foundational model (TSFM) tuned using the collected historical disturbance data to capture the distribution of the structure and dynamics of disturbance scenarios.

17. The system of claim 15, wherein the Bayesian optimization-based diversity search employs an acquisition function configured to select a disturbance scenario that maximizes a novelty metric computation configured to evaluate a diversity of the selected disturbance scenario by computing the average distance of the outcome corresponding to the selected disturbance scenario to k-nearest neighbors in an outcome space, wherein a higher novelty score indicates a higher likelihood that a disturbance scenario produces an outcome different from previously observed system responses.

18. The system of claim 17, wherein the acquisition function implements a Thompson sampling-based acquisition function configured to:
balance exploration of unobserved behaviors with exploitation of regions likely to yield high-diversity outcomes; and
adaptively adjust the balance between exploration and exploitation based on previously observed system responses.

19. The system of claim 15, wherein the processor is further configured to refine the surrogate model by:
selecting a disturbance scenario in the latent space using an acquisition function configured to select the disturbance scenario that maximizes novelty by prioritizing inputs expected to generate unobserved or underrepresented performance of the mechanical system control by the current controller subject to the selected disturbance scenario;
executing the simulation engine to determine the corresponding output of the controlled mechanical system and observe a disturbance-outcome pair;
updating the surrogate model using the observed disturbance-outcome pair; and
sampling the surrogate model using the acquisition function to identify the next disturbance scenario likely to yield a novel outcome.

20. The system of claim 15, wherein the processor is further configured to update the current controller by one or a combination of:
adjusting control parameters using a reinforcement learning framework that optimizes controller performance based on simulated responses to the identified disturbance scenarios;
implementing a robust control strategy that incorporates worst-case disturbance scenarios to enhance system stability under uncertain conditions specified in the identified disturbance scenarios; and
applying an adaptive tuning mechanism that continuously refines the decision-making policies in response to newly encountered disturbance scenarios.
